(19) United States
(12) Patent Application Publication
(10) Pub. No.: US 2026/0361190 A1
(43) Pub. Date: Nov. 12, 2026

(54) METHOD FOR MANUFACTURING A ROTOR OF AN ELECTRIC MACHINE, ROTOR OF AN ELECTRIC MACHINE, AND ELECTRIC MACHINE HAVING A ROTOR

(71) Applicant: Volkswagen Aktiengesellschaft, Wolfsburg (DE)

(72) Inventors: Tim BACHMANN, Wolfsburg (DE); Stefan PROKOPH, Wolfsburg (DE)

(73) Assignee: Volkswagen Aktiengesellschaft, Wolfsburg (DE)

(21) Appl. No.: 19/673,471

(22) Filed: May 11, 2026

(30) Foreign Application Priority Data
May 9, 2025 (DE) 10 2025 117 986.7
Jul. 3, 2025 (DE) 10 2025 126 096.6

(51) Int. Cl. H02K 15/035; H02K 1/276

(52) U.S. Cl. CPC H02K 15/035; H02K 1/276; H02K 2215/00

(57) ABSTRACT

A method for manufacturing a rotor of an electric machine. The rotor including a laminated core, which comprises a plurality of laminations arranged in a manner stacked along an axial direction. At least one magnet pocket is formed in the laminated core for receiving at least one rotor magnet, and at least one clamping tab extending into at least one magnet pocket for fixing a rotor magnet in the magnet pocket in a force-fitting manner. A forming tool is introduced into a magnet pocket. At least one clamping tab is deformed in the magnet pocket from an original state into a target state via the forming tool. At least one rotor magnet is introduced into the magnet pocket. The forming tool is ejected from the magnet pocket, at least in sections, due to the introduction of at least one rotor magnet into the magnet pocket.

This nonprovisional application claims priority under 35 U.S.C. § 119(a) to German Patent Application No. 10 2025 117 986.7, which was filed in Germany on May 9, 2025, and German Patent Application No. 10 2025 126 096.6, which was filed in Germany on Jul. 3, 2025, and which are all herein incorporated by reference.

### BACKGROUND OF THE INVENTION

### Field of the Invention

The invention relates to a method for manufacturing a rotor of an electric machine, a rotor for an electric machine, and an electric machine having a rotor.

### Description of the Background Art

It is known that, in rotors of electric machines, permanent magnets are pressed into magnet pockets provided for this purpose of a laminated core for fixing the permanent magnets on the laminated core in a force-fitting manner. The disadvantage has become clear that a coating of the permanent magnets used for the electrical isolation of the permanent magnets may become damaged during the pressing in. An electrical contacting between the laminated core and the magnets may occur thereby, by means of which, in turn, an unwanted heating of the permanent magnets may take place due to short-circuit current.

### SUMMARY OF THE INVENTION

It is therefore an object of the present invention to at least partially overcome at least one of the disadvantages described above. In particular, the object of the invention is to provide a method for manufacturing a rotor of an electric machine, a rotor of an electric machine, and an electric machine having a rotor, by means of which an unwanted heating of permanent magnets arranged in the rotor may be avoided or reduced.

The above object, in an example, is achieved by a method according to a first aspect of the present invention, by a rotor according to a second aspect of the present invention, and by an electric machine according to a third aspect of the present invention.

Features and details which are described in connection with the method according to the invention also apply, of course, in connection with the rotor according to the invention and/or in connection with the electric machine according to the invention, and vice versa in each case, so that reference always is or may be made interchangeably with respect to the disclosure of the individual aspects of the invention.

According to a first aspect, the present invention relates to a method for manufacturing a rotor of an electric machine, the rotor including a laminated core, which comprises a plurality of laminations, the laminations being arranged in a manner stacked along an axial direction, at least one magnet pocket being formed in the laminated core for receiving at least one rotor magnet in at least one magnet pocket, and at least one clamping tab extending into the magnet pocket for the purpose of fixing a rotor magnet in the magnet pocket, in particular in a force-fitting manner, the method comprising: introducing a forming tool into a magnet pocket; deforming at least one clamping tab in the magnet pocket from an original state into a target state with the aid of the forming tool; introducing at least one rotor magnet into the magnet pocket, in particular after the deformation of at least one clamping tab into the target state or after the introduction of the forming tool into the magnet pocket, so that the rotor magnet is fixed in the magnet pocket with the aid of at least one clamping tab, in particular in a force-fitting manner. The forming tool is ejected from the magnet pocket at least in sections, in particular entirely, due to the introduction of at least one rotor magnet into the magnet pocket.

In particular, it may be provided that the aforementioned steps can be carried out in the indicated sequence. Additionally or alternatively, it is conceivable that at least individual steps of the method are carried out repeatedly and/or at least partially simultaneously.

The examples and mechanisms described in relation to a magnet pocket or a clamping tab or a forming tool may be used in any combination in relation to further magnet pockets or clamping tabs or forming tools.

In other words, a method for manufacturing a rotor of an electric machine is proposed. The rotor can comprise a laminated core, which, in turn, comprises a plurality of laminations. The laminations are stacked along an axial direction, in particular, coaxially or essentially coaxially with regard to their center line. The axial direction preferably extends along or in parallel to a rotation axis of the rotor. Additionally or alternatively, the axial direction may extend along or essentially along the direction of gravitational force, at least while carrying out the method.

At least one magnet pocket can be furthermore formed in the laminated core for receiving at least one rotor magnet. At least one rotor magnet may preferably be designed as a permanent magnet. Additionally or alternatively, multiple magnet pockets may be formed in the laminated core. At least two magnet pockets may be provided with an identical or essentially identical design.

It may preferably be provided that at least one magnet pocket can extend through the laminated core along the axial direction, in particular in relation to its center line, and/or is cut with front ends, in particular along the axial direction. In other words, it may be provided that at least one magnet pocket is designed as a through-hole in the laminated core.

It is furthermore provided that at least one clamping tab can extend into at least one magnet pocket for the purpose of fixing a rotor magnet in the magnet pocket, in particular in a force-fitting manner. It may be provided that a plurality of clamping tabs extend into at least one magnet pocket. In particular, the number and/or arrangement of clamping tabs may be provided with an identical or essentially identical design in relation to at least two magnet pockets. In particular, at least one clamping tab may be designed as an integral component of a lamination or form a monolithic component with a lamination. At least one lamination may preferably be designed as a stamped part.

A forming tool can be introduced into a magnet pocket of the laminated core, in particular along the axial direction, and at least one clamping tab in the magnet pocket is deformed, in particular bent, from an original state into a target state due to the introduction of the forming tool into the magnet pocket. The introduction of the forming tool may take place, in particular, along or in the direction of the direction of gravitational force. The deformation may preferably be a plastic deformation, at least in part, so that the deformed clamping tabs remained in the target state or at least approximately in the target state after a removal or ejection of the forming tool from the magnet pocket.

The introduction of the forming tool into the magnet pocket or the passage of the forming tool through the magnet pocket may take place, at least in part, by machine, in particular with the aid of a pressing apparatus. The pressing apparatus may be designed, in particular, to introduce, in particular press, the forming tool as well as at least one rotor magnet into at least one magnet pocket. The pressing apparatus may comprise at least one magazine, the magazine preferably being designed to receive a forming tool and at least one rotor magnet. In this way, the forming tool to be introduced into a magnet pocket at least one subsequent rotor magnet may be easily and reliably provided.

In particular, the forming tool can be a component other than a rotor magnet. This therefore involves a preparatory deformation of one or multiple clamping tabs with the aid of the forming tool, which is used to prepare an arrangement of at least one rotor magnet in a magnet pocket.

In particular, multiple clamping tabs, in particular all clamping tabs, in a magnet pocket may be deformed from the original state into the target state with the aid of the forming tool.

The target state, i.e., the degree of deformation of the clamping tab or clamping tabs, may be adapted according to the application, and depends, in particular, on the dimensioning of the magnet pocket(s), the clamping tab(s), and the rotor magnet(s). In particular, the target state of at least one clamping tab is designed in such a way that an, in particular electrically isolating, coating of a rotor magnet remains intact during an introduction of the rotor magnet into the magnet pocket, and/or a sufficient clamping force is generated for fixing the rotor magnet with the aid of the clamping tab.

At least one rotor magnet can be introduced into the magnet pocket and fixed in the magnet pocket with the aid of at least one clamping tab, in particular in a force-fitting manner, in particular after the deformation of the at least one clamping tab or multiple clamping tabs in the magnet pocket into the target state. It may preferably be provided that the forming tool is ejected from the magnet pocket at least in sections or entirely, due to the introduction of at least one rotor magnet into the magnet pocket. In other words, due to by the introduction of at least one rotor magnet into the magnet pocket, a forward stroke or forward thrust of the forming tool into the magnet pocket is preferably generated, and it is passed through the magnet pocket or ejected therefrom, at least in sections.

The described procedure may be carried out for at least two magnet pockets, in particular all magnet pockets, of the rotor, in particular simultaneously.

A clamping force of the clamping tabs during the pressing of a rotor magnet into the relevant magnet pocket may be reduced by means of a targeted pre-deformation of clamping tabs in a magnet pocket. A load on the rotor magnet may be reduced hereby, however without compromising a secure fixing of the rotor magnet. In particular, it may be ensured in this way that a coating of the rotor magnet remains intact during the pressing in, and an electrical isolation between the rotor magnet and laminated core is maintained. Short-circuit currents may thus be avoided between the rotor magnet and laminated core, and an undesirable heating of the rotor magnet may be avoided or reduced. An easy and efficient process control results due to the ejection of a forming tool from a magnet pocket by means of an introduction of a rotor magnet into this magnet pocket. In particular, the introduction of the forming tool and the introduction of at least one rotor magnet into a magnet pocket may be implemented at only one work station, by which means a cost-and time-efficient manufacturing of a rotor results.

The forming tool may be preferably introduction into the magnet pocket or passed through the latter, in particular along the axial direction. This means that the forming tool is introduced into the magnet pocket on a first side and guided out of the magnet pocket on a second side opposite the first one. In particular, the method may thus comprise the following steps: passing a forming tool through a magnet pocket, in particular along the axial direction; deforming at least one clamping tab in the magnet pocket from an original state into a target state with the aid of the forming tool or passing the forming tool through the magnet pocket; introducing or pressing at least one rotor magnet into the magnet pocket, in particular after the deformation of at least one clamping tab into the target state or after passing the forming tool through the magnet pocket, so that the rotor magnet is fixed in the magnet pocket with the aid of at least one clamping tab, in particular in a force-fitting manner. Whereby the passing of the forming tool through the magnet pocket taking place, at least in part, by the introduction of at least one rotor magnet into the magnet pocket.

The passing through of the forming tool may preferably take place without a return stroke or essentially without a return stroke or without or essentially without reversing directions. This means that the forming tool is introduced into the magnet pocket along a direction (forward stroke direction or forward thrust direction) and is passed through the magnet pocket exclusively along this direction, i.e., it is, in particular, not or essentially not moved in the opposite direction (return stroke direction). An intermittent standstill of the forming tool is not ruled out hereby. A return stroke-free passage of the forming tool has proven to be advantageous, since the clamping tabs act in terms of their function similarly to barbed hooks, and a return stroke of the forming tool may result in a damage to the clamping tabs.

It may preferably be provided that, at least during the introduction of at least one rotor magnet into the magnet pocket, the forming tool can be in contact, in particular on the end face, with a rotor magnet which, in particular, follows the forming tool, and a forward stroke of the forming tool in the magnet pocket takes place by means of a forward stroke of the rotor magnet which follows, in particular, the forming tool. In this way, the forming tool may be easily and efficiently removed from the magnet pocket, and one or multiple rotor magnets may be positioned in direct sequence in the magnet pocket.

It may furthermore be provided that the introduction of the forming tool and the introduction of at least one rotor magnet can take place from a pressing apparatus, in particular, from a shared magazine of the pressing apparatus. In this way, the forming tool and one or multiple rotor magnets may be provided or pre-positioned efficiently and reliably at a magnet pocket. For example, the forming tool and at least one rotor magnet may be arranged in a stacked manner in the magazine, in particular along the axial direction, before an introduction of the forming tool or at least one rotor magnet into the magnet pocket takes place.

The method may also comprise a capture of the forming tool, in particular in a magazine, for use in a pressing apparatus. In other word, the forming tool may be ejected from the magnet pocket and captured. The forming tool is preferably captured in a magazine, the magazine being able to be used in a pressing apparatus which is designed to introduce, in particular press, the forming tool and/or at least one rotor magnet into the magnet pocket. In this way, an efficient process control results, since the magazine in which the forming tool was captured is subsequently brought to the pressing apparatus and may be re-introduced. At least one rotor magnet may be contained in the magazine prior to the capture of the forming tool, so that the magazine is ready for a new use within the scope of the method according to the invention upon the capture of the forming tool.

At least during the deformation of at least one clamping tab, the forming tool can be guided in the magnet pocket in contact with, at least in sections, or in contact on, at least in sections, a wall of the magnet pocket situated opposite, in particular, the clamping tab at least during the deformation of at least one clamping tab. In other words, it may preferably be provided that, during the deformation of at least one clamping tab, the forming tool rests against a wall of the magnet pocket situated opposite the clamping tab, at least in sections. An effective support of the forming tool may be implemented hereby, and a shaping of the clamping tab predefined by the forming tool may be implemented in a high-quality manner.

It may furthermore be preferably provided that, in the original state, at least one clamping tab can extend into the magnet pocket along an extension direction orthogonal or essentially orthogonal to the axial direction. In other words, it may preferably be provided that the direction along which at least one clamping tab extends into the magnet pocket or in the direction of a center line of the magnet pocket (extension direction) in its original state is oriented orthogonally or essentially orthogonally to the axial direction. This has proven to be advantageous in relation to an easy mounting and manufacturing of the rotor.

In the target state, at least one clamping tab can extend into the magnet pocket along an extension direction at an angle of inclination of no more than 45°, in particular no more than 40°, preferably no more than 35°, particularly preferably no more than 30° or no more than 20° in relation to the axial direction. In other words, it may preferably be provided that the direction along which at least one clamping tab extends into the magnet pocket or in the direction of a center line of the magnet pocket (extension direction) in its target state is inclined no more than 45° (angular degree) in relation to the axial direction.

In particular, the deformation of at least one clamping tab from the original state into the target state can take place in such a way that an angle of inclination is reduced between an extension direction of the clamping tab into the magnet pocket, or in the direction of a center line of the magnet pocket, and the axial direction.

The introduction of the forming tool into the magnet pocket or the passage of the forming tool through the magnet pocket comprises centering the forming tool in the magnet pocket, in particular, between at least one clamping tab and a wall of the magnet pocket situated opposite the clamping tab, preferably by means of a sliding of a centering section of the forming tool along at least one clamping tab, at least in sections.

In other words, it may preferably be provided that the forming tool can be centered in the magnet pocket, in particular between at least one clamping tab and a wall of the magnet pocket situated opposite the clamping tab, in particular during the course of the introduction into the magnet pocket. The centering of the forming tool may preferably take place prior to the deformation of at least one clamping tab or the clamping tabs with the aid of the forming tool. For centering purposes, the forming tool may preferably comprise a centering section. The centering section may preferably comprise a centering chamfer. The centering section may preferably be a section of the forming tool which is introduced into the magnet pocket prior to at least one forming section or prior to all forming sections and/or prior to an end section of the forming tool.

The centering section may preferably form a first end of the forming section, in particular along the axial direction. This preferably relates to a use of the forming tool within the scope of a method according to the invention. In particular, the first end of the forming tool may be introduced into the magnet pocket first.

The deformation of at least one clamping tab with the aid of the forming tool can comprise a step of deforming the clamping tab by means of a sliding of at least one forming section of the forming tool along the clamping tab.

In other words, it may preferably be provided that the deformation of at least one clamping tab from the original state into the target state can take place by a sliding of at least one forming section or at least one forming chamfer of the forming tool along the clamping tab. The forming section may preferably comprise a forming chamfer. An increase in the material thickness of the forming tool in the direction of a clamping tab is implemented by a forming chamfer as the introduction of the forming tool into the magnet pocket progresses. The speed of the deformation may be set by a slope of the forming chamfer at a given introduction speed of the forming tool into the magnet pocket.

At least one forming section may preferably be a section of the forming tool which, in particular along the axial direction, is formed between the first and a second end of the forming tool, in particular along the axial direction, or between a centering section and an end section of the forming tool. This may preferably apply to all forming sections. The arrangement along the axial direction preferably relates to a use of the forming tool within the scope of a method according to the invention.

It may be particularly preferably provided that the deformation of at least one clamping tab with the aid of the forming tool comprises the step of deforming the clamping tab by means of an, in particular consecutive, sliding of a plurality of forming sections of the forming too along the clamping tab, an increasing deformation of the clamping tab taking place, in particular, with each sliding of a forming section along the clamping tab.

In other words, it may be preferably provided that the deformation of at least one clamping tab from the original state into the target state takes place by an, in particular consecutive, sliding of a plurality of forming sections or forming chamfers of the forming tool along the clamping tab. Each forming section may preferably comprise a forming chamfer. In particular, the forming sections or forming chamfers are formed or arranged along the forming tool in such a way that an increasing deformation of the clamping tab takes place as the forward stroke or forward thrust of the forming tool increases in the magnet pocket or with each sliding of a forming section along the clamping tab. By using a plurality of forming sections or forming chamfers for successively deforming a clamping tab, a gentle deformation may be implemented with a moderate propelling force for the forming tool.

At least two or all forming sections may be arranged or formed adjacent to each other, preferably along the axial direction. This preferably relates to a use of the forming tool within the scope of a method according to the invention.

It may furthermore be advantageously provided that the introduction of the forming tool into the magnet pocket and/or the passage of the forming tool through the magnet pocket comprises the step of introducing an end section of the forming tool into the magnet pocket so that the end section extends over all clamping tabs in the magnet pocket, in particular along the axial direction, the end section being designed such that it is recessed with respect to all clamping tabs, in particular while in the target state, in particular so that a clamping of the forming tool in the magnet pocket is released, or the end section is movable through the magnet pocket along all clamping tabs without clamping, in particular while in the target state.

In other words, it may preferably be provided that the introduction of the forming tool into the magnet pocket or the passage of the forming tool through the magnet pocket can comprise an introduction of an end section of the forming tool into the magnet pocket. The end section is preferably designed such that it is recessed in the magnet pocket with respect to all clamping tabs while in the target state, or it is dimensioned in such a way that, when the end section extends over all clamping tabs, in particular along the axial direction, a clamping of the forming tool in the magnet pocket is released, or the forming tool is able to move through the magnet pocket without clamping or with a clearance.

A particularly easy and reliable ejection of the forming tool from the magnet pocket may be implemented by such a design of an end section. If the forming tool was inserted far enough into the magnet pocket that the end section extends over all clamping tabs, a force fit or a clamping no longer exists between the forming tool and the clamping tab or clamping tabs. A force fit of this type or a clamping of this type occurs, in particular, in the region of a forming section, due to the direct contact between the forming tool and the clamping tab or the elasticity of the clamping tab counteracting the deformation. The forming tool may slide out of the magnet pocket or be removed therefrom after the, in particular complete, introduction of the end section, for example due entirely to the effect of gravitational force. A complete introduction of the end section is to be understood to be an introduction such that the end section extends across all clamping tabs, in particular along the axial direction.

The end section may preferably form a second end of the forming section situated, in particular, opposite the first end, in particular along the axial direction. This preferably relates to a use of the forming tool within the scope of a method according to the invention. In particular, the first end of the forming tool may be introduced into the magnet pocket last.

The end section may preferably be a section of the forming tool which follows at least one forming section, in particular, all forming sections, in particular along the axial direction. The arrangement along the axial direction preferably relates to a use of the forming tool within the scope of a method according to the invention.

In particular, the introduction of the forming tool into the magnet pocket may comprise the following, for example, in the specified order: introducing a centering section of the forming tool into the magnet pocket; introducing at least one forming section of the forming tool, in particular all forming sections of the forming tool, into the magnet pocket; and introducing an end section of the forming tool into the magnet pocket.

To implement the aforementioned sequence, the particular sections of the forming tool may be arranged accordingly or be formed on the forming tool, in particular along the axial direction.

The centering section can be designed to center the forming tool in the magnet pocket, in particular between at least one clamping tab and a wall of the magnet pocket situated opposite the clamping tab. Additionally or alternatively, at least one forming section is preferably designed to at least partially deform at least one clamping tab from the original state into the target state. Additionally or alternatively, the end section is designed to release a clamping of the forming tool in the magnet pocket.

It is furthermore conceivable that at least two clamping tabs or two rows of clamping tabs, which run, in particular, along the axial direction, are arranged at a distance from each other along a width direction of the magnet pocket and form a guide channel for guiding the forming tool, in particular along the axial direction, the forming tool being guided in the guide channel in a form-fitting manner, at least temporarily, during the introduction of the forming tool into the magnet pocket and/or during the passage of the forming tool through the magnet pocket. To form a form-fit of this type, at least one continuation or projection may be formed on the forming tool, which engages with a guide channel in a form-fitting manner, at least temporarily, during the introduction of the forming tool into the magnet pocket or the passage of the forming tool through the magnet pocket. An improved guidance of the forming tool in the magnet pocket may be easily and efficiently implemented in this way.

At least two clamping tabs, which form a guide channel, may be arranged in the same position or essentially the same position or arranged in an overlapping manner, at least in sections, in relation to the axial direction.

The width direction preferably extends orthogonally or essentially orthogonally to the axial direction.

It may furthermore be optionally provided that at least two clamping tabs arranged in an offset manner, in particular along a width direction, are deformed by the forming tool from the original state into the target state, the target states of at least two clamping tabs being different, in particular in relation to an angle of inclination between an extension direction of the clamping tabs into the magnet pocket and the axial direction. In other words, it may be provided that a plurality of clamping tabs in the magnet pocket are deformed by the forming tool from the original state into the target state, the target state of at least two clamping tabs arranged in an offset manner, in particular along a width direction, being different. This may be implemented, in particular, by a corresponding contouring of the forming tool, in particular along the width direction. In this way, a distribution of different clamping forces may be implemented for the optimized fixing of a rotor magnet in the magnet pocket.

It is also conceivable that the introduction of the forming tool and/or the introduction of at least one rotor magnet, take(s) place simultaneously, at least in part, for a plurality of magnet pockets, in particular all magnet pockets. A particularly time-efficient process control results therefrom.

Additionally or alternatively, it may be provided that the laminations of the laminated core are pressed together by an application of force along the axial direction at least during the introduction of the forming tool into the magnet pocket, and/or during the passage of the forming tool through the magnet pocket, and/or during the deformation of at least one clamping tab, and/or during the introduction of at least one rotor magnet. This may take place, for example, via at least one hold-down device. At least one hold-down plate may also be arranged on the laminated core to implement a more homogeneous distribution of force. A hold-down device of this type, or a corresponding application of force onto the laminated core, may also be formed or implemented, for example, by a pressing apparatus, which is preferably arranged in contact with the laminated core, at least in sections. Due to such an application of force or a pressing together of the laminated core, a possible bending up of laminations may be avoided during the deformation of clamping tabs.

According to a second aspect, the present invention further relates to a rotor of an electric machine, comprising a laminated core, which comprises a plurality of laminations, the laminations being arranged in a manner stacked along an axial direction, at least one magnet pocket being formed in the laminated core for receiving at least one rotor magnet, and at least one clamping tab extending into at least one magnet pocket for the purpose of fixing a rotor magnet in the magnet pocket, in particular in a force-fitting manner, and at least one rotor magnet being fixed by at least one clamping tab in at least one magnet pocket, in particular in a force-fitting manner, the rotor having been manufactured according to a method according to the first aspect of the present invention. The same advantages already described in relation to a method according to the invention are derived in relation to a rotor according to the invention.

A rotor manufactured in the manner according to the invention is characterized, in particular, by an intact coating of the rotor magnets and an existing electrical isolation between the rotor magnets and the laminated core.

According to a third aspect, the present invention further relates to an electric machine, comprising a rotor according to the second aspect of the present invention. The same advantages already described in relation to a method according to the invention and/or a rotor according to the invention are thus derived in relation to an electric machine according to the invention.

The electric machine may be preferably designed as an electric motor, in particular, as an electric traction motor for a vehicle, in particular a passenger car.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a view of a method;

FIG. 2 schematically shows a view of a rotor of an electric machine;

FIG. 3 schematically shows a view of a rotor of an electric machine;

FIG. 4 schematically shows a view of a rotor of a forming tool;

FIG. 5 schematically shows a view of a rotor of an electric machine;

FIG. 6 schematically shows a view of an introduction of forming tools into magnet pockets;

FIG. 7 schematically shows a view of a rotor of an electric machine;

FIG. 8 schematically shows a view of a forming tool in a magnet pocket;

FIG. 9 schematically shows a view of an introduction of rotor magnets into magnet pockets;

FIG. 10 schematically shows a view of an electrical machine; and

FIG. 11 schematically shows a view of a pressing apparatus.

### DETAILED DESCRIPTION

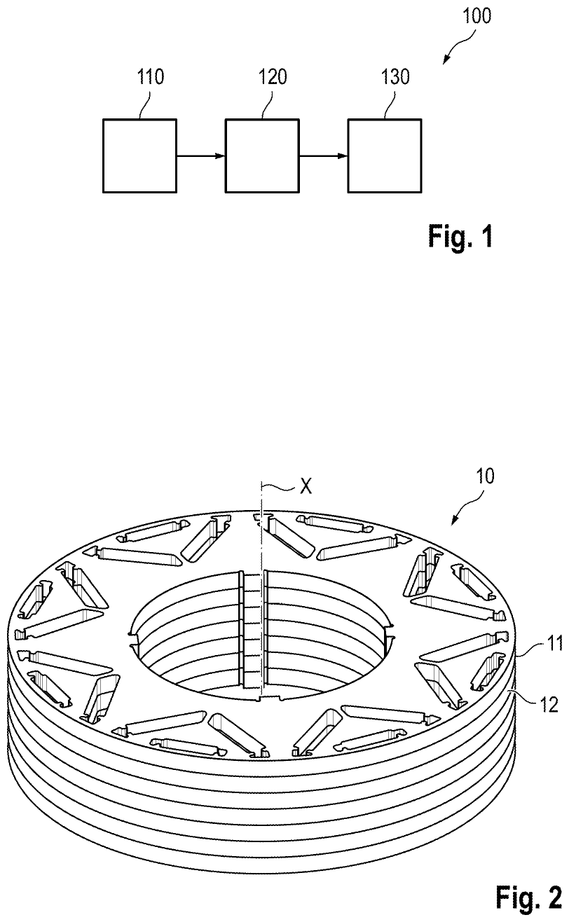

FIG. 1 shows a schematic view of a method 100 for manufacturing a rotor 10 of an electric machine 50, rotor 10 including a laminated core 11, which comprises a plurality of laminations 12, laminations 12 being arranged in a manner stacked along an axial direction X, at least one magnet pocket 13 being formed in laminated core 11 for receiving at least one rotor magnet 14, and at least one clamping tab 15 extending into at least one magnet pocket 13 for the purpose of fixing a rotor magnet 14 in magnet pocket 13, in particular in a force-fitting manner, method 100 comprising: introducing 110 a forming tool 16 into a magnet pocket 13; deforming 120 at least one clamping tab 15 in magnet pocket 13 from an original state I into a target state II with the aid of forming tool 16; introducing 130 at least one rotor magnet 14 into magnet pocket 13, in particular after deformation 120 of the at least one clamping tab 15 into target state II, so that rotor magnet 14 is fixed in magnet pocket 13, in particular in a force-fitting manner, with the aid of at least one clamping tab 15. Whereby forming tool 16 is ejected from magnet pocket 13, at least in sections, due to introduction 130 of at least one rotor magnet 14 into magnet pocket 13.

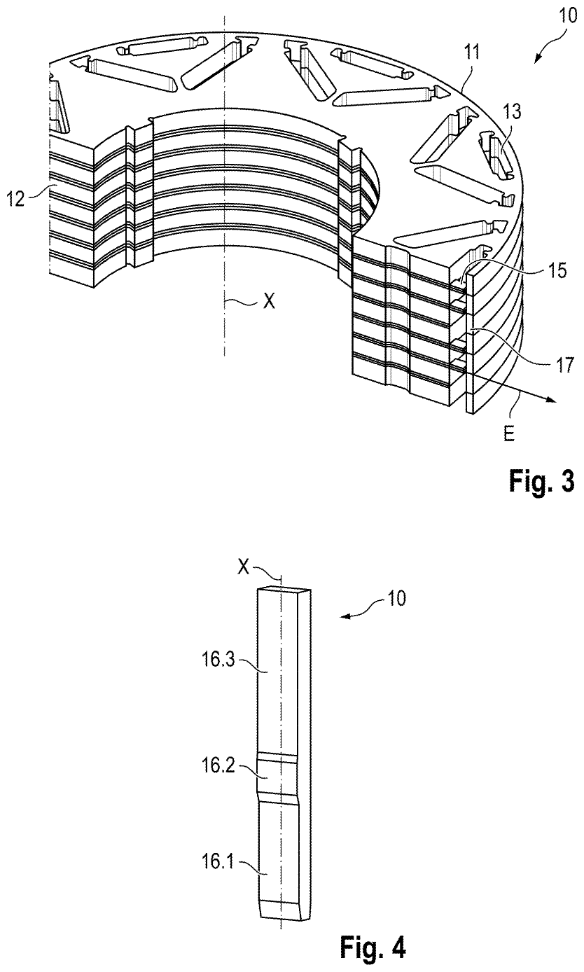

FIG. 2 shows a schematic view of a rotor 10 an electric machine 50. FIG. 3 shows a schematic sectional view of this rotor 10. Rotor 10 comprises a laminated core 11, which comprises a plurality of laminations 12, laminations 12 being arranged in a manner stacked along an axial direction X, at least one magnet pocket 13 being formed in laminated core 11 for receiving at least one rotor magnet 14, and at least one clamping tab 15 extending into at least one magnet pocket 13 for the purpose of fixing a rotor magnet 14 in magnet pocket 13, in particular in a force-fitting manner.

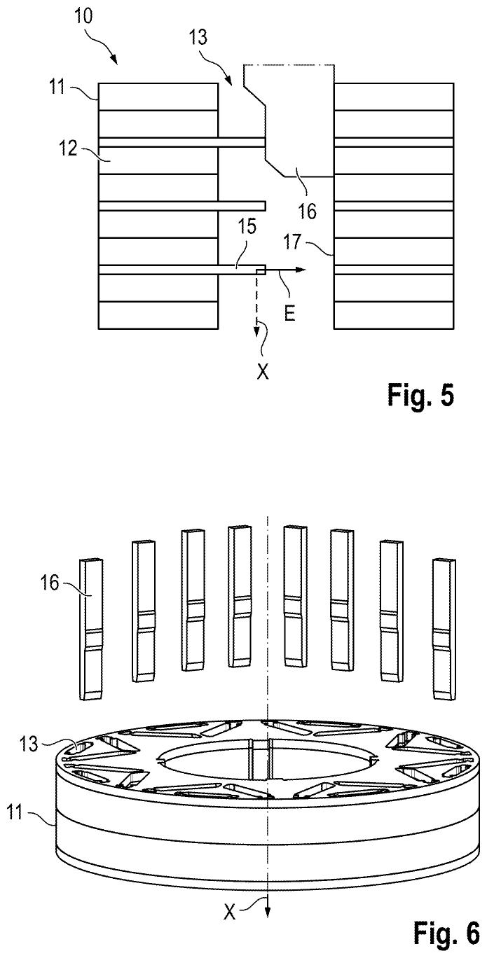

FIG. 3 shows rotor 10 prior to introduction 110 of forming tool 16 into magnet pockets 13. Clamping tabs 15 are thus in an original state I, which is also illustrated in a simplified manner in FIG. 5, clamping tabs 15 extending in original state I into magnet pockets 13 along an extension direction E orthogonal or essentially orthogonal to axial direction X.

FIG. 4 shows a schematic view of a forming tool 16, which comprises a centering section 16.1, a forming section 16.2, and also an end section 16.3.

Centering section 16.1 forms a first end of forming tool 16 along its axial extension, the first end being introduced into magnet pocket 13 first or prior to forming section 16.2 within the scope of a method according to the invention. A centering chamfer is formed on the free end of centering section 16.1

It is furthermore apparent from FIG. 5 how forming tool 16 is introduced into magnet pocket 13 and is centered between a clamping tab 15 and a wall of magnet pocket 13 situated opposite clamping tab 15 with the aid of centering section 16.1.

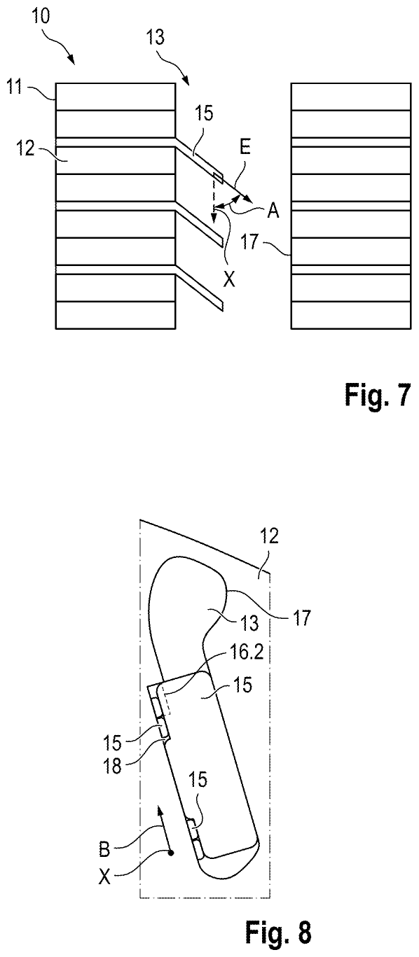

Forming section 16.2 is formed with a forming chamfer adjacent to centering section 16.1, clamping tab 15 being deformed from original state I illustrated in FIG. 5 into target state II illustrated in FIG. 7 by sliding the forming chamfer of forming section 16.2 thereon.

It is furthermore apparent from FIG. 4 that end section 16.3 formed adjacent to the forming section is designed to be recessed with respect to forming section 16.2 and thus with respect to all clamping tabs 15 deformed into target state II, so that a clamping of forming tool 16 in magnet pocket 13 is released when end section 16.3 extends over all clamping tabs 15 in magnet pocket 13.

Since the ejection of forming tool 16 from a magnet pocket 13 takes place by introducing a rotor magnet 14, end section 16.3 illustrated in FIG. 4 may be designed to be significantly shorter or be omitted altogether.

FIG. 6 schematically visualizes an introduction 110 of forming tools 16 of this type into magnet pockets 13 along axial direction X. FIG. 7 schematically shows a view of a rotor 10 after introduction 110 of a forming tool 16 into magnet pocket 13 or after a passage of a forming tool 16 through magnet pocket 13. It is apparent that, by introducing 110 forming tool 16 into magnet pocket 13 or by passing forming tool 16 through magnet pocket 13, clamping tabs 15 are deformed, in particular bent, into target state II, clamping tabs 15 extending into magnet pocket 13 in target state II along an extension direction E at an angle of inclination A of no more than 45° to axial direction X.

FIG. 8 shows a schematic representation of a forming tool 16 in a magnet pocket 13, the viewing direction being directed along axial direction X. It is apparent that at least two clamping tabs 15 are arranged at a distance from each other along a width direction B of magnet pocket 13 and form a guide channel 18 for guiding forming tool 16, in particular along axial direction X, forming tool 16 being guided in guide channel 18 in a form-fitting manner during introduction 110 of forming tool 16 into magnet pocket 13 or during the passage of forming tool 16 through magnet pocket 13.

In the present case, all clamping tabs 15 are deformed to the same extent by forming tool 16. However, it may also be provided that at least two clamping tabs 15 are deformed by forming tool 16 from original state I into target state II, and target states II of at least two clamping tabs 15 are different, in particular in relation to an angle of inclination A between an extension direction E of clamping tabs 15 into magnet pocket 13 and axial direction X. This may be implemented by a corresponding contouring of forming tool 16, which is illustrated by way of example as a dashed line in FIG. 8.

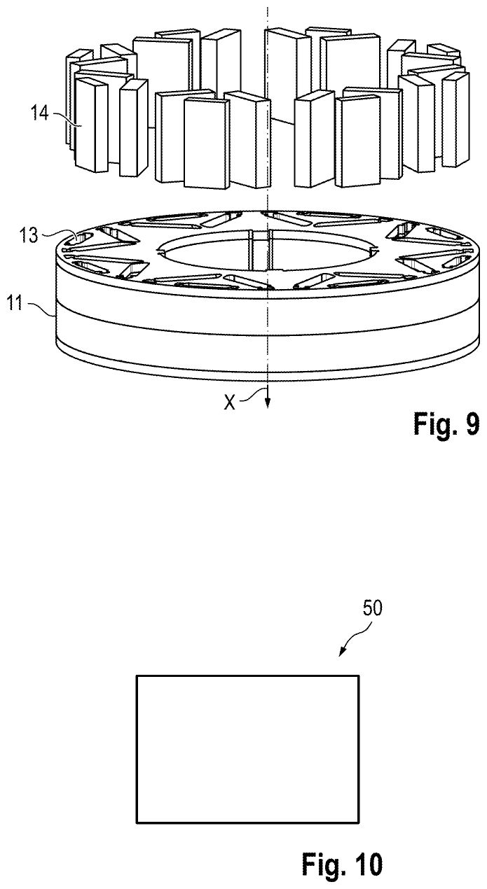

Following deformation 120 of one or multiple clamping tabs 15 into target state II, rotor magnets 14 may be introduced into magnet pockets 13, as is illustrated schematically in FIG. 9.

FIG. 10 furthermore shows a schematic view of an electric machine 50, including a rotor 10 according to the second aspect of the present invention.

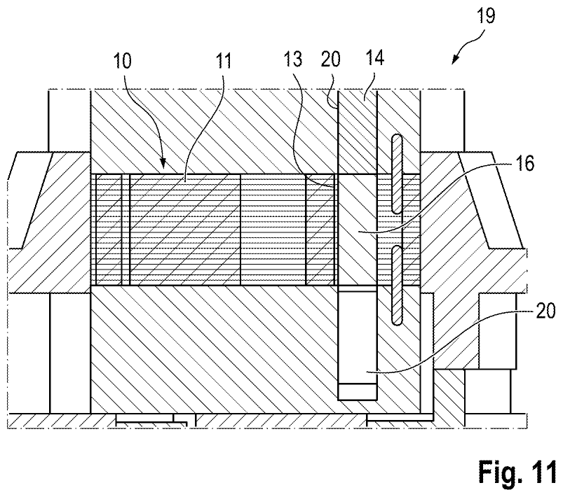

FIG. 11 further shows a schematic view of a pressing apparatus 19 for introducing a forming tool 16 as well as at least one rotor magnet 14 into a magnet pocket 13. Pressing apparatus 19 comprises at least one magazine 20, magazine 20 being designed to receive a forming tool 16 and at least one rotor magnet 14. In FIG. 11, forming tool 16 has already been introduced into magnet pocket 13 from magazine 20.

Starting in the state illustrated in FIG. 11, rotor magnet 14 is now introduced into magnet pocket 13 from magazine 20, and forming tool 16 is ejected hereby from magnet pocket 13.

It is apparent that, at least during introduction 130 of rotor magnet 14 into magnet pocket 13, forming tool 16 is in in contact with rotor magnet 14 on the front side, and a forward stroke of forming tool 16 in magnet pocket 13 takes place by a forward stroke of rotor magnet 14 in magnet pocket 13.

By introducing rotor magnet 14 into magnet pocket 13, forming tool 16 is ejected from magnet pocket 13 and captured in a magazine 20 for use in pressing apparatus 19.

The above explanation of the specific embodiments describes the present invention exclusively within the scope of examples. Individual features of the specific embodiments may, of course, be freely combined with each other if technically reasonable, without departing from the scope of the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a rotor of an electric machine, the rotor comprising a laminated core that comprises a plurality of laminations, the laminations being arranged in a manner stacked along an axial direction, at least one magnet pocket being formed in the laminated core to receive at least one rotor magnet, and at least one clamping tab extending into at least one magnet pocket to fix a rotor magnet in the magnet pocket in a force-fitting manner, the method comprising:
introducing a forming tool into a magnet pocket;
deforming at least one clamping tab in the magnet pocket from an original state into a target state via the forming tool;
introducing at least one rotor magnet into the magnet pocket so that the rotor magnet is fixed in the magnet pocket in a force-fitting manner, via at least one clamping tab; and
ejecting the forming tool from the magnet pocket, at least in sections, due to the introduction of at least one rotor magnet into the magnet pocket.

2. The method according to claim 1, wherein, at least during the introduction of at least one rotor magnet into the magnet pocket, the forming tool is in in contact with the rotor magnet on a front side, and a forward stroke of the forming tool in the magnet pocket takes place by a forward stroke of the rotor magnet.

3. The method according to claim 1, wherein the introduction of the forming tool and the introduction of at least one rotor magnet take place with the aid of a pressing apparatus with the aid of a shared magazine of the pressing apparatus.

4. The method according to claim 1, wherein the method further comprises:
capturing the forming tool in a magazine, for using in a pressing apparatus.

5. The method according to claim 1, wherein, at least during the deformation of at least one clamping tab, the forming tool is guided in the magnet pocket in contact, at least in sections, with a wall of the magnet pocket situated opposite the clamping tab.

6. The method according to claim 1, wherein the introduction of the forming tool into the magnet pocket further comprises centering the forming tool in the magnet pocket between at least one clamping tab and a wall of the magnet pocket situated opposite the clamping tab via a sliding of a centering section of the forming tool along at least one clamping tab, at least in sections.

7. The method according to claim 1, wherein the deformation of at least one clamping tab with the aid of the forming tool comprises:
deforming the clamping tab by a sliding of at least one forming section of the forming tool along the clamping tab.

8. The method according to claim 7, wherein the deformation of at least one clamping tab with the aid of the forming tool comprises: deforming the clamping tab via a sliding of a plurality of forming sections of the forming tool on the clamping tab, wherein an increasing deformation of the clamping tab takes place with each sliding of a forming section along the clamping tab.

9. The method according to claim 1, wherein the introduction of the forming tool into the magnet pocket comprises: introducing an end section of the forming tool into the magnet pocket so that the end section extends over all clamping tabs in the magnet pocket, wherein the end section is designed to be recessed with respect to all clamping tabs so that a clamping of the forming tool in the magnet pocket is released.

10. The method according to claim 1, wherein at least two clamping tabs are arranged at a distance from each other along a width direction of magnet pocket and form a guide channel for guiding the forming tool along the axial direction, the forming tool being guided in the guide channel, at least temporarily, in a form-fitting manner during the introduction of the forming tool into the magnet pocket.

11. The method according to claim 1, wherein at least two clamping tabs are deformed by the forming tool from the original state into the target state, the target state of at least two clamping tabs being different in relation to an angle of inclination between an extension direction of the clamping tabs into the magnet pocket and the axial direction.

12. The method according to claim 1, wherein the introduction of the forming tool, and/or the introduction of at least one rotor magnet takes place substantially simultaneously, at least in part, for a plurality of magnet pockets or all magnet pockets.

13. The method according to claim 1, wherein the laminations of the laminated core are pressed together by an application of force along the axial direction, at least during the deformation of at least one clamping tab.

14. A rotor of an electric machine, the rotor comprising
a laminated core that comprises a plurality of laminations, the laminations being arranged in a manner stacked along an axial direction;
at least one magnet pocket formed in the laminated core to receive at least one rotor magnet;
at least one clamping tab extending into at least one magnet pocket for the purpose of fixing a rotor magnet in the magnet pocket in a force-fitting manner, and
at least one rotor magnet being fixed by at least one clamping tab in at least one magnet pocket in a force-fitting manner, the rotor having been manufactured according to the method according to claim 1.

15. An electric machine comprising the rotor according to claim 14.
